(19) United States
(12) Patent Application Publication
(10) Pub. No.: US 2011/0200029 A1
(43) Pub. Date: Aug. 18, 2011

(54) WIRELESS COMMUNICATION CLUSTERING METHOD AND SYSTEM FOR COORDINATED MULTI-POINT TRANSMISSION AND RECEPTION

(75) Inventors: Hamidreza Farmandar, Ottawa (CA); Amir Keyvan Khandani, Kitchener (CA); Mohammadhadi Baligh, Kanata (CA); Jianglei Ma, Kanata (CA); Aaron James Callard, Ottawa (CA)

(73) Assignee: NORTEL NETWORKS LIMITED, Mississauga, ON (CA)

(21) Appl. No.: 13/123,077

(22) PCT Filed: Nov. 3, 2009
(86) PCT No.: PCT/CA2009/001585

§ 371 Date: Apr. 7, 2011

Related U.S. Application Data
(60) Provisional application No. 61/110,738, filed on Nov. 3, 2008.

(51) Int. Cl. H04W 4/00

(52) U.S. Cl. 370/338

(57) ABSTRACT

A method and system for identifying cell clusters within a coordinated multiple point wireless transmission network in order to reduce scheduling complexity while optimizing throughout and performance. The network includes a total number of cells served by corresponding base stations. The BSC divides the entire network of cells into clusters of cells and forwards this clustering information to all mobile devices. A cluster of cell candidates is a subset of the total number of cells within the network. The mobile device then provides to a base station controller the identity of a cluster of preferred cells selected from the cluster of cell candidates. The base station controller selects at least one base station located within the cluster of preferred cells to establish communication with the mobile device. A wireless connection is then established between the selected at least one base station and the mobile device.

### FIELD OF THE INVENTION

The present invention relates generally to wireless communication, and in particular to a system and method for mobile device centric clustering suitable for coordinated multipoint transmission and reception.

### BACKGROUND OF THE INVENTION

In the dynamic field of wireless communications, technological advancements are constantly occurring in order to make it possible for mobile device users to enjoy consistent and quality performance even as the capacity and speed of mobile communication networks improves. While the current generation of mobile telecommunication networks, collectively known as third generation (“3G”) is still prevalent, the next generation of mobile telecommunication technology known as Long Term Evolution (“LTE”), marked as fourth generation (“4G”), is right around the corner. Thus, there is an increased demand and interest in systems that can address this new generation of mobile communication technology and provide approaches that improve bandwidth while reducing bit error rates in wireless transmissions.

One approach that has become popular is the use of Coordinated multiple point (“CoMP”) transmission/reception for LTE-A in order to improve coverage and to increase cell-edge and average cell throughputs. CoMP transmission and reception is also considered as an effective approach for inter-cell interference coordination (“ICIC”) in LTE-A due to inherent joint scheduling/processing at the coordinated cells. In CoMP, the signals from a mobile device are received from several base stations. The technique is based on the known multiple input, multiple output (“MIMO”) approach in that the signals are combined in a central unit. The result of this approach inherently leads to better signal quality. While in a traditional MIMO system, the downlink base station antennas are located at one point, the CoMP system provides for an array of at least two antennas at different locations.

Coordination among all base stations in the cellular communication system provides a significant increase in cell-edge and average cell throughputs. However, data/channel state information (“CSI”) sharing among all base stations in the system requires high backhaul capacity and is often too complex to implement. To reduce the complexity, one consideration is to provide cooperation among a limited number of base stations for communicating with a particular mobile device, also referred to as user equipment (“UE”). One issue related to CoMP transmission and reception involves determining the coordinated cell cluster serving a specific UE in order to have, for example, the largest cell throughput for an accepted level of scheduling complexity and backhaul capacity.

Two common cell clustering techniques are what are known as Pure UE-Specific Clustering, and Fixed Clustering. The Pure UE-Specific Clustering approach involves selecting a cluster of coordinated base stations to serve a particular UE based on long-term channel conditions. In this approach, the cluster of coordinated cells is chosen based on the preference of the UE. For a fixed cluster size, this approach provides the largest throughput gain. However, this approach requires scheduling among all base stations in the system rather than the base stations in the coordinated cluster. This is due to the fact that the coordinated clusters corresponding to different UEs may overlap thus requiring coordination among all overlapping clusters, which can be the entire network. Thus, a Pure UE-Specific Clustering approach is very complex from a scheduling point of view.

In the Fixed Clustering approach, the network is divided into non-intersecting coordinated clusters, and scheduling is required only among the base stations in the cluster for serving any UE located in the same cluster. This approach has low scheduling complexity. However, it provides limited throughput gain.

Therefore, what is needed is a system and method for implementing a clustering approach by using a CoMP technology that is both easy to schedule and provides enhanced throughput performance and gain as compared with known CoMP implementations.

### SUMMARY OF THE INVENTION

The present invention advantageously provides a method and system for identifying cell clusters within a coordinated multiple point transmission network in order to reduce scheduling complexity while optimizing throughout and performance. In accordance with one aspect of the invention, a method of coordinated multi-point transmission in a wireless communication network is provided. The network includes a total number of cells served by corresponding base stations. The method includes receiving, from a mobile device within the network, an identity of a cluster of preferred cells selected from a cluster of cell candidates where the cluster of cell candidates represent a subset of the total number of cells within the network, selecting at least one base station located within the cluster of preferred cells to establish communication with the mobile device, and establishing a wireless connection between the selected at least one base station and the mobile device.

In accordance with another aspect of the invention, a base station controller in a coordinated multi-point wireless communication network is provided. The base station controller is in wireless communication with a total number of cells served by corresponding base stations. The base station controller is operable to receive, from a mobile device within the network, an identity of a cluster of preferred cells selected from a cluster of cell candidates where the cluster of cell candidates represents a subset of the total number of cells within the network, select at least one base station located within the cluster of preferred cells to establish communication with the mobile device, and establish a wireless connection between the selected at least one base station and the mobile device.

In accordance with yet another aspect of the invention, a system for improving performance in a wireless coordinated multi-point transmission network, where the network has a total number of cells, is provided. The system includes at least one base station serving a corresponding cell within the total number of network cells, and a base station controller in wireless communication with the at least one base station. The base station controller is operable to receive, from a mobile device within the network, an identity of a cluster of preferred cells selected from a cluster of cell candidates where the cluster of cell candidates represents a subset of the total number of cells within the network, select at least one of the at least one base station serving the cluster of preferred cells to establish communication with the mobile device, and establish a wireless connection between the selected at least one base station and the mobile device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a cellular communication system;

FIG. 2 is a block diagram of an example base station that might be used to implement some embodiments of the present invention;

FIG. 3 is a block diagram of an example wireless device that might be used to implement some embodiments of the present invention;

FIG. 4 is a block diagram of an example relay station that might be used to implement some embodiments of the present invention;

FIG. 5 is a block diagram of a logical breakdown of an example OFDM transmitter architecture that might be used to implement some embodiments of the present invention;

FIG. 6 is a block diagram of a logical breakdown of an example OFDM receiver architecture that might be used to implement some embodiments of the present invention;

FIG. 7 is a block diagram of an SC-FDMA transmitter used in accordance with the principles of the present invention;

FIG. 8 is a block diagram of an SC-FDMA receiver used in accordance with the principles of the present invention;

FIG. 9 is a diagram illustrating the UE-specific clustering method of the present invention;

FIG. 10 is a graph used to illustrate the SINR geometry for different clustering approaches and the effectiveness of the UE-specific clustering method of the present invention; and

FIG. 11 is a flowchart illustrating the UE-specific clustering method of the present invention.

### DETAILED DESCRIPTION OF THE INVENTION

As an initial matter, while certain embodiments are discussed in the context of wireless networks operating in accordance with the 3rd Generation Partnership Project (“3GPP”) evolution, e.g., Long Term Evolution (“LTE”) standard, etc., the invention is not limited in this regard and may be applicable to other broadband networks including those operating in accordance with other orthogonal frequency division multiplexing (“OFDM”)-based systems including WiMAX (IEEE 802.16) and Ultra-Mobile Broadband (“UMB”), etc. Similarly, the present invention is not limited solely to OFDM-based systems and can be implemented in accordance with other system technologies, e.g., code division multiple access (“CDMA”), single carrier frequency division multiple access (“SC-FDMA”), etc.

Of note, although the term “base stations” is used herein, it is understood that these devices are also referred to as “eNodeB” or “eNB” devices in LTE environments. Accordingly, the use of the term “base station” herein is not intended to limit the present invention to a particular technology implementation. Rather, the term “base station” is used for ease of understanding, it being intended to be interchangeable with the term “eNodeB” or “eNB” within the context of the present invention. Similarly, the terms “wireless terminal” or “wireless device” are used interchangeably with the term “UE” to indicate a user device, or user equipment, in a wireless communication network.

Before describing in detail exemplary embodiments that are in accordance with the present invention, it is noted that the embodiments reside primarily in combinations of apparatus components and processing steps related to a system and method for implementing CoMP transmission and reception in a wireless cellular communication system by determining clusters of cooperating cells and sectors for serving any UE in the system and assigning cell and sector clusters for each UE. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

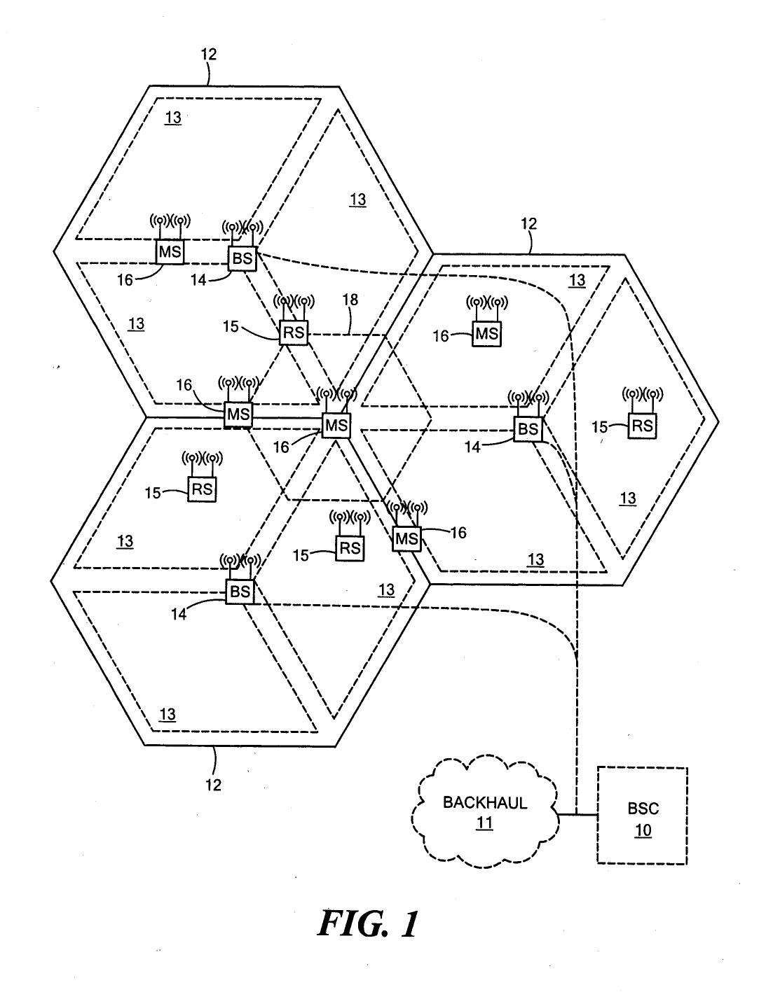

Referring now to the drawing figures in which like reference designators refer to like elements, there is shown in FIG. 1, a base station controller (“BSC”) 10 which controls wireless communications within multiple cells 12, which cells are served by corresponding base stations (“BS”) 14. In some configurations, each cell is further divided into multiple sectors 13 or zones (not shown). In general, each base station 14 facilitates communications using OFDM with mobile and/or wireless terminals/devices (“MS”)16, which are within the cell 12 associated with the corresponding base station 14. The movement of the mobile devices 16 in relation to the base stations 14 results in significant fluctuation in channel conditions. As illustrated, the base stations 14 and mobile devices 16 may include multiple antennas to provide spatial diversity for communications. In some configurations, relay stations 15 may assist in communications between base stations 14 and wireless devices 16. Wireless devices 16 can be handed off 18 from any cell 12, sector 13, zone (not shown), base station 14 or relay 15 to an other cell 12, sector 13, zone (not shown), base station 14 or relay 15. In some configurations, base stations 14 communicate with each and with another network (such as a core network or the Internet, both not shown) over a backhaul network 11. In some configurations, a base station controller 10 is not needed.

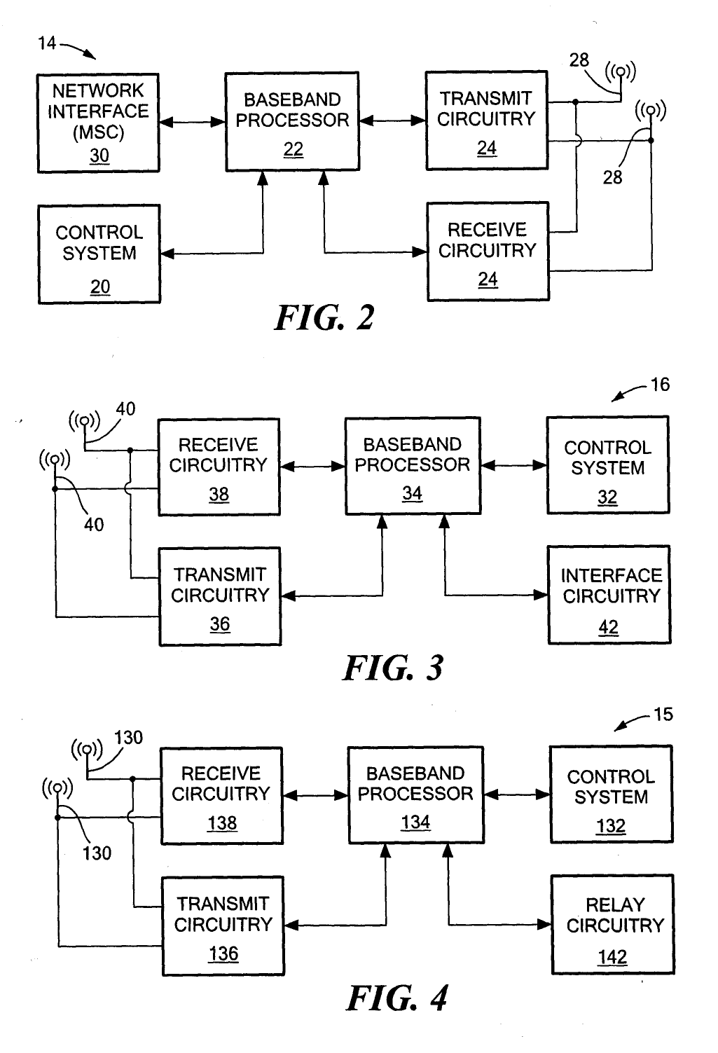

With reference to FIG. 2, an example of a base station 14 is illustrated. The base station 14 generally includes a control system 20, a baseband processor 22, transmit circuitry 24, receive circuitry 26, multiple antennas 28, and a network interface 30. The receive circuitry 26 receives radio frequency signals bearing information from one or more remote transmitters provided by mobile devices 16 (illustrated in FIG. 3) and relay stations 15 (illustrated in FIG. 4). A low noise amplifier and a filter (not shown) may cooperate to amplify and remove broadband interference from the signal for processing. Down-conversion and digitization circuitry (not shown) will then down-convert the filtered, received signal to an intermediate or baseband frequency signal, which is then digitized into one or more digital streams.

The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (DSPs) or application-specific integrated circuits (ASICs). The received information is then sent across a wireless network via the network interface 30 or transmitted to another mobile device 16 serviced by the base station 14, either directly or with the assistance of a relay 15.

On the transmit side, the baseband processor 22 receives digitized data, which may represent voice, data, or control information, from the network interface 30 under the control of control system 20, and encodes the data for transmission. The encoded data is output to the transmit circuitry 24, where it is modulated by one or more carrier signals having a desired transmit frequency or frequencies. A power amplifier (not shown) will amplify the modulated carrier signals to a level appropriate for transmission, and deliver the modulated carrier signals to the antennas 28 through a matching network (not shown). Modulation and processing details are described in greater detail below.

With reference to FIG. 3, an example of a mobile device 16 is illustrated. Similarly to the base station 14, the mobile device 16 will include a control system 32, a baseband processor 34, transmit circuitry 36, receive circuitry 38, multiple antennas 40, and user interface circuitry 42. The receive circuitry 38 receives radio frequency signals bearing information from one or more base stations 14 and relays 15. A low noise amplifier and a filter (not shown) may cooperate to amplify and remove broadband interference from the signal for processing. Down-conversion and digitization circuitry (not shown) will then down-convert the filtered, received signal to an intermediate or baseband frequency signal, which is then digitized into one or more digital streams.

The base band processor 34 processes the digitized received signal to extract the information or data bits conveyed in the received signal. This processing typically comprises demodulation, decoding, and error correction operations. The baseband processor 34 is generally implemented in one or more digital signal processors (“DSPs”) and application specific integrated circuits (“ASICs”).

For transmission, the baseband processor 34 receives digitized data, which may represent voice, video, data, or control information, from the control system 32, which it encodes for transmission. The encoded data is output to the transmit circuitry 36, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 40 through a matching network (not shown). Various modulation and processing techniques available to those skilled in the art are used for signal transmission between the mobile device and the base station, either directly or via the relay station.

In OFDM modulation, the transmission band is divided into multiple, orthogonal carrier waves. Each carrier wave is modulated according to the digital data to be transmitted. Because OFDM divides the transmission band into multiple carriers, the bandwidth per carrier decreases and the modulation time per carrier increases. Since the multiple carriers are transmitted in parallel, the transmission rate for the digital data, or symbols, on any giver carrier is lower than when a single carrier is used.

OFDM modulation utilizes the performance of an Inverse Fast Fourier Transform (“IFFT”) on the information to be transmitted. For demodulation, the performance of a Fast Fourier Transform (“FFT”) on the received signal recovers the transmitted information. In practice, the IFFT and FFT are provided by digital signal processing carrying out an Inverse Discrete Fourier Transform (“IDFT”) and Discrete Fourier Transform (“DTF”), respectively. Accordingly, the characterizing feature of OFDM modulation is that orthogonal carder waves are generated for multiple bands within a transmission channel. The modulated signals are digital signals having a relatively low transmission rate and capable of staying within their respective bands. The individual carrier waves are not modulated directly by the digital signals. Instead, all carrier waves are modulated at once by IFFT processing.

In operation, OFDM is preferably used for at least downlink transmission from the base stations 14 to the mobile devices 16. Each base station 14 is equipped with “n” transmit antennas 28 (n>=1), and each mobile terminal 16 is equipped with “n” receive antennas 40 (m>=1). Notably, the respective antennas can be used for reception and transmission using appropriate duplexers or switches and are so labeled only for clarity.

When relay stations 15 are used, OFDM is preferably used for downlink transmission from the base stations 14 to the relays 15 and from relay stations 15 to the mobile devices 16.

With reference to FIG. 4, an example of a relay station 15 is illustrated. Similarly to the base station 14, and the mobile device 16, the relay station 15 will include a control system 132, a baseband processor 134, transmit circuitry 136, receive circuitry 138, multiple antennas 130, and relay circuitry 142. The relay circuitry 140 enables the relay 14 to assist in communications between a base station 16 and mobile devices 16. The receive circuitry 138 receives radio frequency signals bearing information from one or more base stations 14 and mobile devices 16. A low noise amplifier and a filter (not shown) may cooperate to amplify and remove broadband interference from the signal for processing. Down-conversion and digitization circuitry (not shown) will then down-convert the filtered, received signal to an intermediate or baseband frequency signal, which is then digitized into one or more digital streams.

The baseband processor 134 processes the digitized received signal to extract the information or data bits conveyed in the received signal. This processing typically comprises demodulation, decoding, arid error correction operations. The baseband processor 134 is generally implemented in one or more digital signal processors (DSPs) and application specific integrated circuits (ASICs).

For transmission the baseband processor 134 receives digitized data, which may represent voice, video, data, or control information, from the control system 132, which it encodes for transmission. The encoded data is output to the transmit circuitry 136, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 130 through a matching network (not shown). Various modulation and processing techniques available to those skilled in the art are used for signal transmission between the mobile device and the base station, either directly or indirectly via a relay station, as described above.

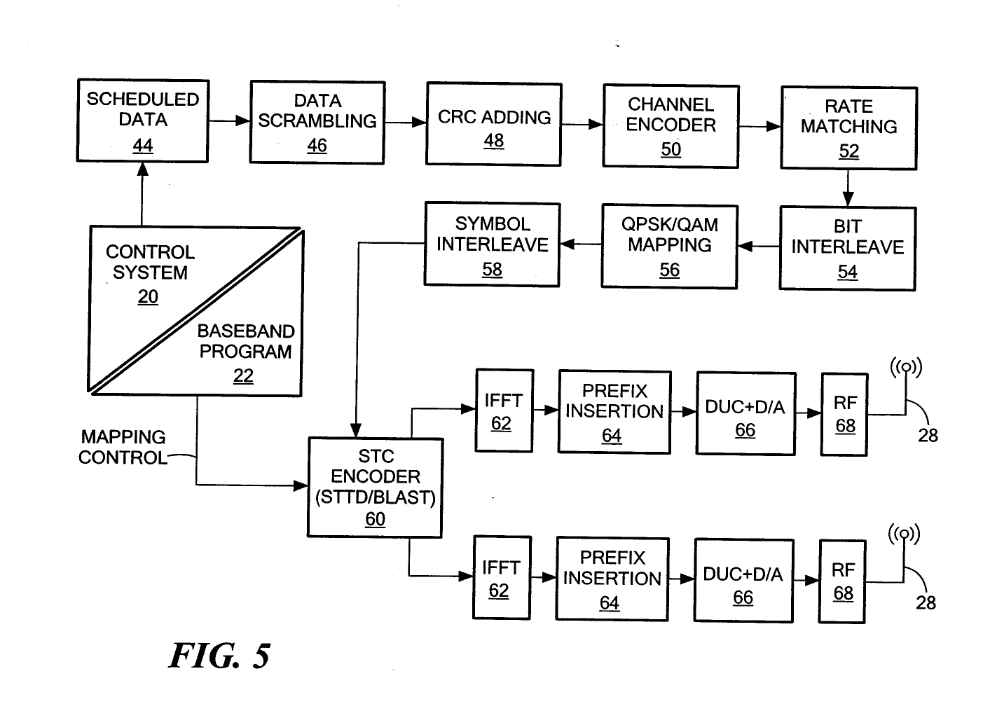

With reference to FIG. 5, a logical OFDM transmission architecture is described. Initially, the base station controller 10 will send data to be transmitted to various mobile devices 16 to the base station 14, either directly or with the assistance of a relay station 15. The base station 14 may use the channel quality indicators (“CQIs”) associated with the mobile devices to schedule the data for transmission as well as select appropriate coding and modulation for transmitting the scheduled data. The CQIs may be directly from the mobile devices 16 or determined at the base station 14 based on information provided by the mobile devices 16. In either case, the CQI for each mobile device 16 is a function of the degree to which the channel amplitude (or response) varies across the OFDM frequency band.

Scheduled data 44, which is a stream of bits, is scrambled in a manner reducing the peak-to-average power ratio associated with the data using data scrambling logic 46. A cyclic redundancy check (“CRC”) for the scrambled data is determined and appended to the scrambled data using CRC adding logic 48. Next, channel coding is performed using channel encoder logic 50 to effectively add redundancy to the data to facilitate recovery and error correction at the mobile device 16. Again, the channel coding for a particular mobile device 16 is based on the CQI. In some implementations, the channel encoder logic 50 uses known Turbo encoding techniques. The encoded data is then processed by tale matching logic 52 to compensate for the data expansion associated with encoding.

Bit interleaver logic 54 systematically reorders the bits in the encoded data to minimize the loss of consecutive data bits. The resultant data bits are systematically mapped into corresponding symbols depending on the chosen baseband modulation by mapping logic 56. Preferably, Quadrature Amplitude Modulation (“QAM”) or Quadrature Phase Shift Ft Key (“QPSK”) modulation is used. The degree of modulation is preferably chosen based on the CQI for the particular mobile device. The symbols may be systematically reordered to further bolster the immunity of the transmitted signal to periodic data loss caused by frequency selective fading using symbol interleaver logic 58.

At this point, groups of bits have been mapped into symbols representing locations in an amplitude and phase constellation. When spatial diversity is desired, blocks of symbols are then processed by space-time block code (“STC”) encoder logic 60, which modifies the symbols in a fashion making the transmitted signals more resistant to interference and more readily decoded at a mobile device 16. The STC encoder logic 60 will process the incoming symbols and provide “n” outputs corresponding to the number of transmit antennas 28 for the base station 14. The control system 20 and/or baseband processor 22 as described above with respect to FIG. 5 will provide a mapping control signal to control STC encoding. At this point, assume the symbols for the “n” outputs are representative of the data to be transmitted and capable of being recovered by the mobile device 16.

For the present example, assume the base station 14 has two antennas 28 (n=2) and the STC encoder logic 60 provides two output streams of symbols. Accordingly, each of the symbol streams output by the STC encoder logic 60 is sent to a corresponding IFFT processor 62, illustrated separately for ease of understanding. Those skilled in the art will recognize that one or more processors may be used to provide such digital signal processing, alone or in combination with other processing described herein. The IFFT processors 62 will preferably operate on the respective symbols Lu provide an inverse Fourier Transform. The output of the IFFT processors 62 provides symbols in the time domain. The time domain symbols arc grouped into frames, which are associated with a prefix by prefix insertion logic 64. Each of the resultant signals is up-converted in the digital domain to an intermediate frequency and converted to an analog signal via the corresponding digital up-conversion (“DUC”) and digital-to-analog (D/A) conversion circuitry 66. The resultant (analog) signals are then simultaneously modulated at the desired RF frequency, amplified, and transmitted via the RF circuitry 68 and antennas 28. Notably, pilot signals known by the intended mobile device 16 are scattered among the sub-carriers. The mobile device 16, which is discussed in detail below, will use the pilot signals for channel estimation.

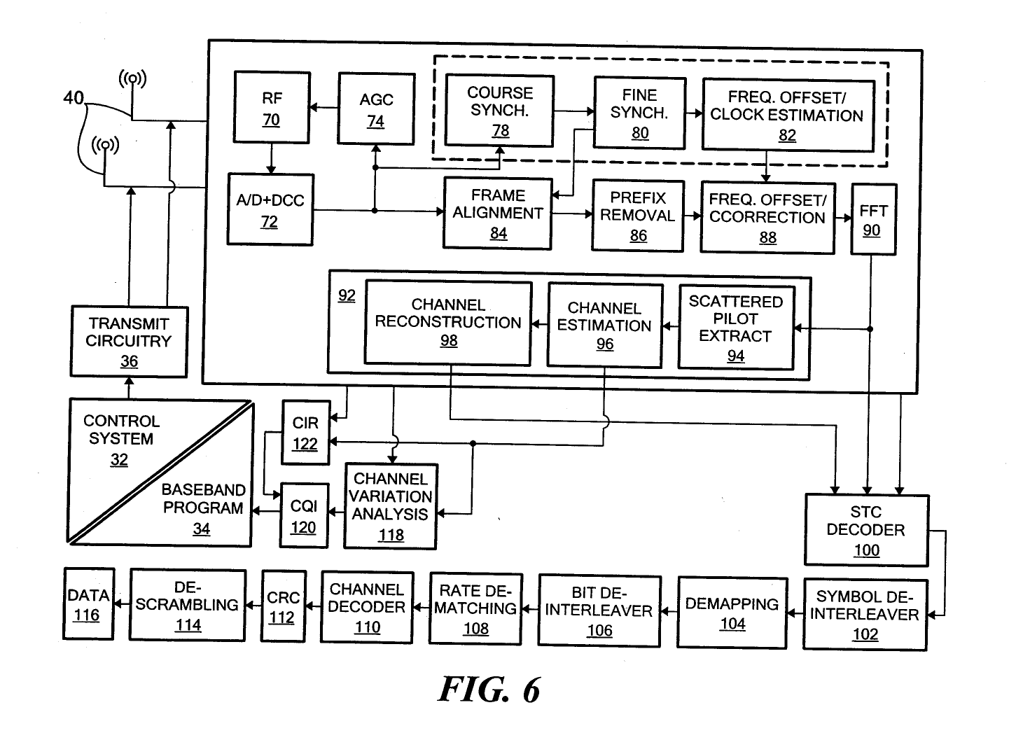

Reference is now made to FIG. 6 to illustrate reception of the transmitted signals by a mobile device 16, either directly from base station 14 or with the assistance of relay 15. Upon arrival of the transmitted signals at each of the antennas 40 of the mobile device 16, the respective signals are demodulated and amplified by corresponding RF circuitry 70. For the sake of conciseness and clarity, only one of the two receive paths is described and illustrated in detail. Analog-to-digital (A/D) converter and down-conversion circuitry 72 digitizes and down-converts the analog signal for digital processing. The resultant digitized signal may be used by automatic gain control circuitry (“AGC”) 74 to control the gain of the amplifiers in the RF circuitry 70 based on the received signal level.

Initially, the digitized signal is provided to synchronization logic 76, which includes coarse synchronization logic 78, which buffers several OFDM symbols and calculates art auto-correlation between the two successive OFDM symbols. A resultant time index corresponding to the maximum of the correlation result determines a line synchronization search window, which is used by fine synchronization logic 80 to determine a precise framing starting position based on the headers. The output of the fine synchronization logic 80 facilitates frame acquisition by frame alignment logic 84. Proper framing alignment is important so that subsequent FFT processing provides an accurate conversion from the time domain to the frequency domain. The line synchronization algorithm is based on the correlation between the received pilot signals carried by the headers and a local copy of the known pilot data. Once frame alignment acquisition occurs, the prefix of the OFDM symbol is removed with prefix removal logic 86 and resultant samples are sent to frequency offset correction logic 88, which compensates for the system frequency offset caused by the unmatched local oscillators in the transmitter and the receiver. Preferably, the synchronization logic 76 includes frequency offset and clock estimation logic 82, which is based on the headers to help estimate such effects on the transmitted signal and provide those estimations to the correction logic 88 to properly process OFDM symbols.

At this point, the OFDM symbols in the time domain are ready for conversion to the frequency domain using FFT processing logic 90. The results are frequency domain symbols, which are sent to processing logic 92. The processing logic 92 extracts the scattered pilot signal using scattered pilot extraction logic 94, determines a channel estimate based on the extracted pilot signal using channel estimation logic 96, and provides channel responses for all sub-carriers using channel reconstruction logic 98. In order to determine a channel response for each of the sub-carriers, the pilot signal is essentially multiple pilot symbols that are scattered among the data symbols throughout the OFDM sub-carriers in a known pattern in both time and frequency. Continuing with FIG. 6, the processing logic compares the received pilot symbols with the pilot symbols that are expected in certain sub-carriers at certain times to determine a channel response for the sub-carriers in which pilot symbols were transmitted. The results are interpolated to estimate a channel response for most, if not all, of the remaining sub-carriers for which pilot symbols were not provided. The actual aid interpolated channel responses are used to estimate an overall channel response, which includes the channel responses for most, if not all, of the sub-carriers in the OFDM channel.

The frequency domain symbols and channel reconstruction information, which are derived from the channel responses for each receive path are provided to an STC decoder 100, which provides STC decoding on both received paths to recover the transmitted symbols. The channel reconstruction information provides equalization information to the STC decoder 100 sufficient to remove the effects of the transmission channel when processing the respective frequency domain symbols.

The recovered symbols are placed back in order using symbol de-interleaver logic 102, which corresponds to the symbol interleaver logic 58 of the transmitter. The de-interleaved symbols are then demodulated or dc-mapped to a corresponding bitstream using de-mapping logic 104. The bits are then de-interleaved using bit de-interleaver logic 106, which corresponds to the bit interleaver logic 54 of the transmitter architecture. The de-interleaved bits are then processed by rate de-matching logic 108 and presented to channel decoder logic 110 to recover the initially scrambled data and the CRC checksum. Accordingly, CRC logic 112 removes the CRC checksum, checks the scrambled data in traditional fashion, and provides it to the de-scrambling logic 114 for de-scrambling using the known base station de-scrambling code to recover the originally transmitted data 116.

In parallel to recovering the data 116, a CQI 120, or at least information sufficient to create a CQI at the base station 14, is determined and transmitted to the base station 14. As noted above, the CQI may be a function of the carrier-to-interference ratio (CM) 122, as well as the degree to which the channel response varies across the various sub-carriers in the OFDM frequency band. For this embodiment, the channel gain for each sub-carrier in the OFDM frequency band being used to transmit information is compared relative to one another to determine the degree to which the channel gain varies across the OFDM frequency band. This channel analysis can be performed by a channel variation analysis technique 118. Although numerous techniques are available to measure the degree of variation, one technique is to calculate the standard deviation of the channel gain for each sub-carrier throughout the OFDM frequency band being used to transmit data.

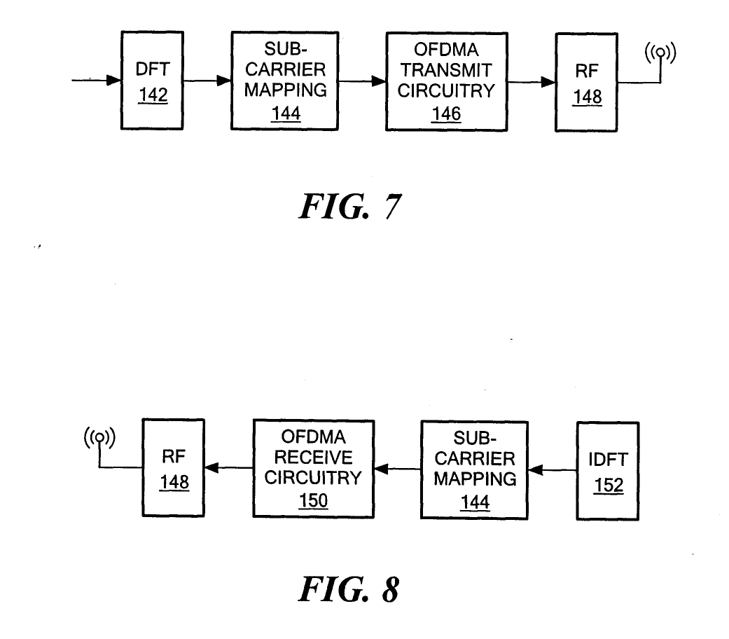

FIGS. 7 and 8 illustrate, respectively, an example of a single-carrier frequency division multiple access (“SC-FDMA”) transmitter and receiver for a single-in single-out (“SISO”) configuration in accordance with an embodiment of the present application. In SISO configurations, mobile stations transmit on one antenna and base stations and/or relay stations receive on one antenna. FIGS. 7 and 8 illustrate the basic signal processing steps needed at the transmitter and receiver for the LTE SC-FDMA uplink. In some embodiments, SC- is used. SC-FDMA is a modulation and multiple access scheme introduced for the uplink of 3GPP LTE broadband wireless fourth generation (4G) air interface standards, and the like. SC-FDMA can be viewed as a discrete Fourier transform (“DFT”) pre-2 coded orthogonal frequency-division multiple access (“OFDMA”) scheme, or, it can be viewed as a single carrier (“SC”) multiple access scheme.

Thus, as shown in FIGS. 7 and 8, an RF signal 148 is subjected to DFT pre-coding 142 on the transmitter side, sub-carrier mapping 144, and standard OFDMA transmit circuitry 146, while OFDMA receive circuitry 150 and sub-carrier mapping 144 on the receiver side present a signal subject to inverse discrete Fourier transform (“IDFT”) 152 at the receiver output.

There are several similarities in the overall transceiver processing of SC-FDMA and OFDMA. Those common aspects between OFDMA and SC-FDMA are illustrated in the OFDMA transmit circuitry 146 and OFDMA receive circuitry 150, as they would be obvious to a person having ordinary skill in the art in view of the present specification. SC-FDMA is distinctly different from OFDMA because of the DFT pre-coding of the modulated symbols, and the corresponding IDFT of the demodulated symbols. Because of this pre-coding, the SC-FDMA sub-carriers are not independently modulated as in the case of the OFDMA sub-carriers. As a result, the peak-to-average-power-ratio (“PAPR”) of SC-FDMA signal is lower than the PAPR of the OFDMA signal. Lower PAPR greatly benefits the mobile device in terms of transmit power efficiency.

The present invention provides a UE-specific clustering approach where the cluster of eNBs serving a particular UE is a subset of a larger cluster rather than the whole network. This approach provides a simplified scheduling implementation (as opposed to the complex scheduling of the pure UE-specific clustering approach) and superior performance (as opposed to the poor performance of the fixed clustering approach). The subset cell cluster chosen from the larger cell cluster can vary depending upon different sub-bands and different times. The system and method of the present invention requires scheduling among the eNBs in the larger cluster (rather than all eNBs in the network) and can provide most of the achievable throughput gain.

The network is divided into clusters of cells. These clusters are referred to as the CoMP measurement cell sets (“CMCS”). The CMCS is cell-specific rather than mobile device-specific. The identity of cells and total number of cells within the CMCS is not fixed, and can vary depending upon different frequency-bands and can vary in time. This reflects the dynamic nature of the clustering method and system of the present invention. Thus, the CMCS is a cell cluster representing the total number of “candidate” eNBs 14 that are available to a specific mobile device 16.

A mobile device 16 in a specific cell 12 then measures the received power from all eNBs 14 in the selected cell cluster (CMCS). The mobile device 16 reports to BSC 10 with a subset number of cells within the CMCS from which it receives the highest power. This subset is called the CoMP Reporting Cell Set (“CRCS”). The CRCS is mobile device-specific rather than cell-specific. BSC 10 receives a transmission from each mobile device 16, informing the BSC 10 of each UE's cell cluster preference (CRCS). Based on this report, BCS 10 decides which eNBs 14 in the cells within the CRCS should actually perform the CoMP transmission, for that mobile device 16. The set of cells selected by BCS 10 contain the eNB 14 which will actually perform the CoMP transmission. This set of cells is a subset of the CRCS, and is called the CoMP Active Cell Set (“CACS”). It should be noted that although only the eNBs 14 in the CACS perform CoMP transmission to the given mobile device 16, scheduling coordination is required within the whole CMCS as different CACSs corresponding to different mobile devices 16 may overlap.

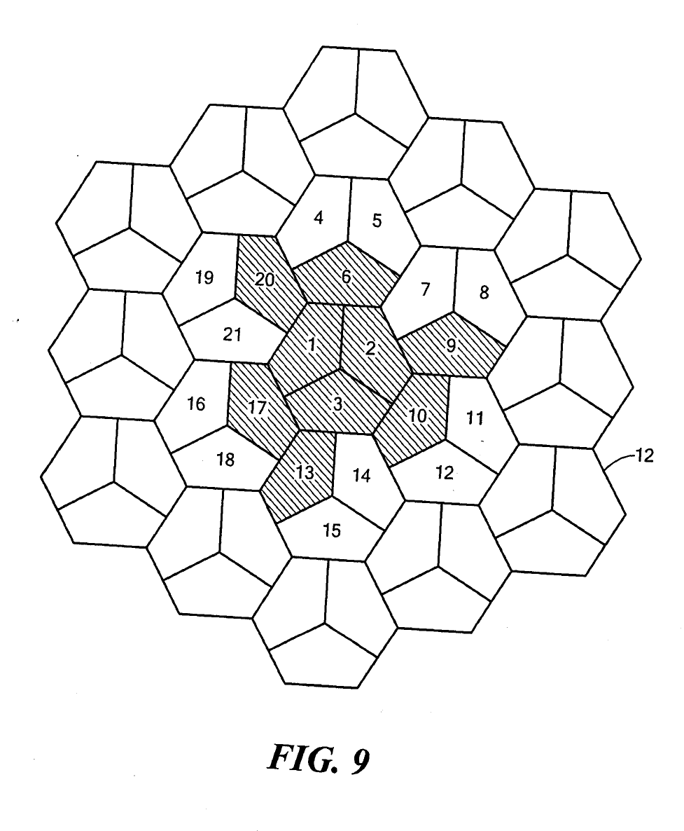

FIG. 9 illustrates an example of the mobile device-specific clustering approach of the present invention. The network is divided into a number of CMCS's. In this example, a CMCS of 9 cells is shown. As discussed above, the selection of this number can be based on a number of different factors including the strength of the eNBs 14 in the cell, the frequency band it operates in, and the level of interference within that frequency band. The mobile device 16 then chooses a subset (CRCS) of the CMCS. The mobile device 16 makes the selection of “preferred” cells (CRCS) taking into consideration such things as channel resources and the received power from different eNBs 14 in the CMCS. Thus, in an exemplary embodiment, a mobile device 16 can select a number of eNB 14, for example, 3 or 4 eNBs, by taking into consideration the level of signal power received from the eNBs 14 within the CMCS. In another embodiment, if the mobile device 16 selects 6 preferred cells as its CRCS, this might produce a higher performance but will also consume more channel resources, than a selection of few preferred cells. Thus, for example, in FIG. 9, cell 1 can be coordinated with two other cells, e.g., cell 10 and cell 17, within the entire shaded area (CMCS). Once the mobile device 16 has made its CRCS selection, it sends a report to the BSC 10, informing it that it has selected, in this instance, three cells, and requests that the BSC 10 choose which of the base stations 14 within the selected three cells should actually provide the connection to the mobile device 16.

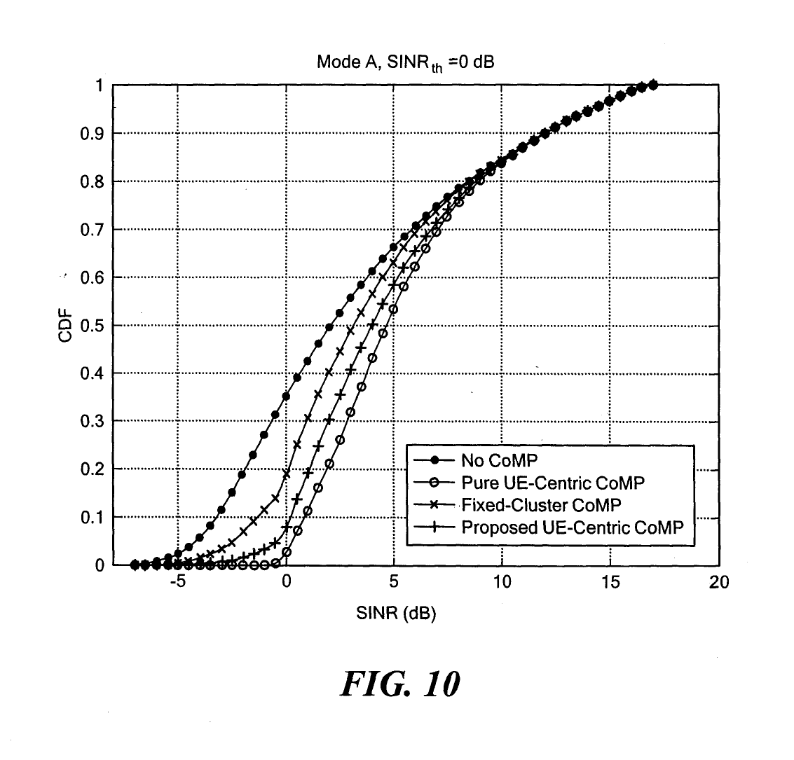

FIG. 10 is a graph that compares the signal-to-interference-plus-noise ratio (“SINR”) geometry for different clustering approaches. The illustration in FIG. 9 considers the downlink of a cellular network having 19 hexagonal sites and three cells per site, an inter site distance (“ISD”) of 500 m, and an antenna front-to-back gain of 20 dB. The channels are modeled based on distance-dependent attenuation and shadowing. CoMP transmission is only applied to mobile devices 16 with received (pre-CoMP-)SINR less than SINRth=0 dB. The post-CoMP-SINR (SINR after CoMP) is calculated by turning two (out of 56) interfering signals into the desired signal. This corresponds to open-loop transmit diversity scheme on three coordinated eNBs 14.

The graph of FIG. 10 represents the SINR geometry for different clustering approaches. The graph illustrates the cumulative distribution function (“CDF”) vs. the SINR for four different scenarios: when no CoMP is used, when the Pure mobile device-centric CoMP approach is used, when the Fixed-Cluster CoMP approach is used, and when the proposed mobile device-centric clustering approach of the present invention is used. Generally, a higher mobile device 16 performance is associated with a relatively high SINR.

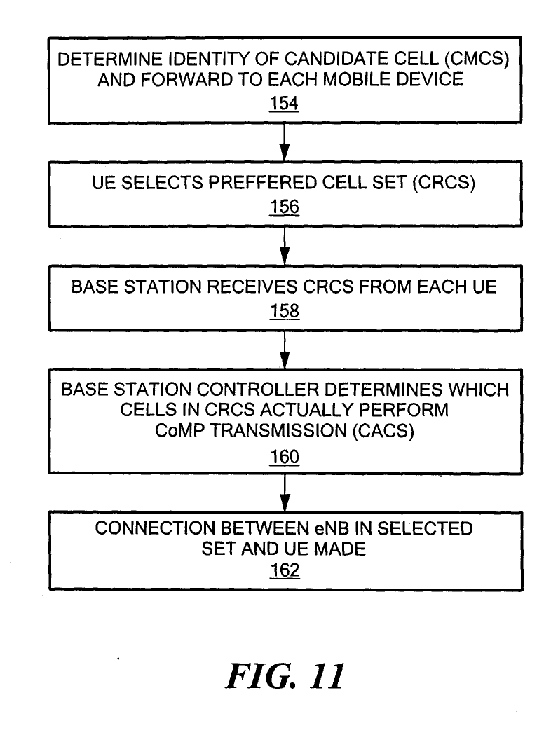

FIG. 11 is a flowchart illustrating an exemplary clustering method of the present invention. Initially, BCS 10 divides the entire network of cells into a cluster of cells (CMCS), and forwards the CMCS to each mobile device 16, at step 154. As discussed above, this number can depend on a number of factors, can vary within each frequency band, and can vary over time. The mobile device 16 then determines, at step 156 its “preferred” cells (CRCS) based on, for example, the strength of the signal received from the eNBs 14 within those cells. BSC 10 receives the cell cluster selection (CRCS) from the mobile device 16 at step 158. BSC 10 then determines which cells in the mobile device's CRCS will actually perform the CoMP transmission, at step 160. BCS 10 then instructs an eNB 14 within one of the preferred cells to make the actual connection with the target mobile device 16.

The method and system of the present invention overcomes the problems of the prior art by reducing the overall scheduling complexity associated with prior art CoMP cell clustering approach, while increasing overall system performance.

The inventive method and system implements CoMP transmission and reception in a wireless cellular communication system by selecting clusters of cooperating cells or sectors that serve mobile devices within the system. This invention is a novel scheme to assign cell/sector clusters for each mobile device. The clustering approach of the present invention is a UE-centric approach where the cluster of eNBs serving a specific mobile device is a subset of a larger cluster rather than the whole network. This approach requires scheduling among the eNBs only in the larger cluster, rather than all eNBs in the network, and provides optimal performance and throughput.

FIGS. 1 to 11 provide one specific example of a communication system that could be used to implement embodiments of the application. It is to be understood that embodiments of the application can be implemented with communications systems having architectures that are different than the specific example, but that operate in a manner consistent with the implementation of the embodiments as described herein.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A method of coordinated multi-point transmission in a wireless communication network, the network having a total number of cells served by corresponding base stations, the method comprising:
receiving, from a mobile device within the network, an identity of a cluster of preferred cells selected from a cluster of cell candidates, the cluster of cell candidates representing a subset of the total number of cells within the network;
selecting at least one base station located within the cluster of preferred cells to establish communication with the mobile device; and
establishing a wireless connection between the selected at least one base station and the mobile device.

2. The method of claim 1, wherein the mobile device is operable using a set of frequency bands, wherein the cluster of cell candidates varies depending on an operational frequency band from the set of frequency bands.

3. The method of claim 1, wherein the cluster of cell candidates varies over time.

4. The method of claim 1, wherein the cluster of cell candidates varies according to interference within each operational frequency band.

5. The method of claim 1, wherein the cluster of preferred cells is determined based on a power level received from each base station within the cluster of preferred cells.

6. The method of claim 1, wherein the cluster of cell candidates varies based on resource availability within the network.

7. The method of claim 1, further comprising coordinating scheduling of the wireless connection between the selected at least one base station and the mobile device if a cell within the cluster of preferred cells for the mobile device is identical to a cell within the cluster of preferred cells of a different mobile device.

8. A base station controller in a coordinated multi-point wireless communication network, the base station controller in wireless communication with a total number of cells served by corresponding base stations, the base station controller operable to:
receive, from a mobile device within the network, an identity of a cluster of preferred cells selected from a cluster of cell candidates, the cluster of cell candidates representing a subset of the total number of cells within the network;
select at least one base station located within the cluster of preferred cells to establish communication with the mobile device; and
establish a wireless connection between the selected at least one base station and the mobile device.

9. The base station controller of claim 8, wherein the mobile device is operable using a set of frequency bands, wherein the cluster of cell candidates varies depending on an operational frequency band from the set of frequency bands.

10. The base station controller of claim 8, wherein the cluster of cell candidates varies over time.

11. The base station controller of claim 8, wherein the cluster of cell candidates varies according to interference within each operational frequency band.

12. The base station controller of claim 8, wherein the cluster of preferred cells is determined based on a power level received from each base station within the cluster of preferred cells.

13. The base station controller of claim 8, wherein the cluster of cell candidates varies based on resource availability within the network.

14. A system for improving performance in a wireless coordinated multi-point transmission network, the network having a total number of cells, the system comprising:
at least one base station serving a corresponding cell within the total number of network cells; and
a base station controller in wireless communication with the at least one base station, the base station controller operable to:
receive, from a mobile device within the network, an identity of a cluster of preferred cells selected from a cluster of cell candidates, the cluster of cell candidates representing a subset of the total number of cells within the network;
select at least one of the at least one base station serving the cluster of preferred cells to establish communication with the mobile device; and
establish a wireless connection between the selected at least one base station and the mobile device.

15. The system of Clam 14, wherein the mobile device is operable using a set of frequency bands, wherein the cluster of cell candidates varies depending on an operational frequency band from the set of frequency bands.

16. The system of Clam 14, wherein the cluster of cell candidates varies over time.

17. The system of Clam 14, wherein the cluster of cell candidates varies according to interference within each operational frequency band.

18. The system of Clam 14, wherein the cluster of preferred cells is determined based on power level received from each base station within the cluster of preferred cells.

19. The system of Clam 14, wherein the cluster of cell candidates varies based on resource availability within the network.

20. The system of claim 14, the base station controller further operable to coordinate scheduling of the wireless connection between the selected at least one base station and the mobile device if a cell within the cluster of preferred cells for the mobile device is identical to a cell within the cluster of preferred cells of a different mobile device.
